(19) United States
(12) Patent Application Publication
(10) Pub. No.: US 2025/0296579 A1
(43) Pub. Date: Sep. 25, 2025

(54) Method and Device for Identifying a Malfunction in a Surroundings Model of an Automated Driving Function

(71) Applicant: Bayerische Motoren Werke Aktiengesellschaft, Muenchen (DE)

(72) Inventors: Marco BAUMGARTL, Gilching (DE); Alexander BORN, Muenchen (DE); Sean BROWN, Deggendorf (DE); Frank KEIDEL, Poing (DE); Tilman NOWAK, Erfurt (DE); Christian UNGER, Maisach (DE)

(21) Appl. No.: 18/861,934

(22) PCT Filed: Apr. 27, 2023
(86) PCT No.: PCT/EP2023/061108

§ 371 Date: Oct. 31, 2024

(30) Foreign Application Priority Data
May 20, 2022 (DE) 10 2022 112 745.1

(51) Int. Cl. B60W 50/02; G06F 11/07; G08G 1/04

(52) U.S. Cl. CPC B60W 50/0205; G06F 11/0739; G06F 11/079; G08G 1/04; B60W 2050/021

(57) ABSTRACT

Provided is a method for identifying a malfunction in a surroundings model that is used by an automated driving function of a motor vehicle. The method includes determining a first deviation between a target trajectory determined by the surroundings model and an actual trajectory travelled by the motor vehicle and/or a second deviation between a course of a road determined by the surroundings model and a course of a road determined by camera software; and identifying the malfunction based on the first and/or the second deviation.

### BACKGROUND AND SUMMARY

The present disclosure relates to a method for identifying a malfunction in a surroundings model of an automated driving function. Additionally or alternatively, a data processing device is provided that is configured to carry out at least part of the method. Additionally or alternatively, an automated motor vehicle comprising at least part of the data processing device is provided. Additionally or alternatively, a computer program is provided that comprises commands that, when the program is executed by a computer, cause the computer to carry out at least part of the method. Additionally or alternatively, a non-transitory computer readable medium is provided that comprises commands that, when the commands are executed by a computer, cause the computer to carry out at least part of the method.

With an automated driving function of a motor vehicle, it is annoying for a driver of the motor vehicle if the motor vehicle picks up a geometry of a road, or the road profile, erroneously and the motor vehicle therefore does not follow the road as required, e.g., because it missteers. In this case, it may be necessary for the driver to intervene by taking over control of the lateral and/or longitudinal guidance of the motor vehicle. If frequent intervention is necessary, this diminishes the driver's confidence in the automated driving function.

During development of the automated driving function, there is therefore particular attention on situations in which the motor vehicle missteers and does not follow the real road profile.

A test driver discovering such abnormal behavior by the motor vehicle makes a note of it and manually starts data logging in order to record the incident.

This data logging can be analyzed by the development and it is possible to determine what part of the automated driving function is responsible for the abnormal behavior. However, capturing the data and analysis requires many manual steps.

The reason for the abnormal behavior and what part of the automated driving function has triggered this abnormal behavior are generally not evident to the test driver, however.

The reason for the abnormal behavior is conventionally performed by developers primarily by way of manual visual analysis of the logged data. This involves the developers visually comparing the road geometry computed by the surroundings model with reality (trajectory taken or camera images).

It is moreover known practice to use the trajectory taken by a driver as training data for the automated driving function (so-called behavioral cloning).

Against the background of this prior art, the object of the present disclosure is to specify a device and a method that are each suitable for enriching the prior art described above.

The object is achieved by way of the features of the independent claim. The subclaims contain preferred developments of the invention.

Accordingly, the object is achieved by way of a method for identifying a malfunction in a surroundings model used by an automated driving function of a motor vehicle. The method comprises determining a first variance between a target trajectory determined by the surroundings model and an actual trajectory taken by the motor vehicle. Additionally or alternatively, the method comprises determining a second variance between a road profile determined by the surroundings model and a road profile determined by a camera software.

Furthermore, the method comprises identifying the malfunction on the basis of the first and/or the second variance.

The method described above may be a computer-implemented method, i.e., one, multiple or all of the steps of the method can be carried out by a computer, or a data processing device.

An automated driving function can be understood to mean a function of the motor vehicle that is configured to at least temporarily undertake specific parts or all of the driving task, if necessary together with other automated driving functions.

The surroundings model may be a so-called road surroundings model. The surroundings model can be ascertained on the basis of sensor data from multiple, in particular different, sensors in the motor vehicle. This can be accomplished by fusing the sensor data. The road surroundings model can comprise information about the road profile and the target trajectory of the motor vehicle.

A trajectory can be understood to mean a path along which the motor vehicle is intended to travel (so-called target trajectory) or actually travels (so-called actual trajectory). Besides position information, the trajectory can also comprise a temporal component, i.e., when the motor vehicle is supposed to be, or is, where.

The two possibilities described above for determining the variance have the common inventive concept of detecting and if necessary then analyzing abnormal behavior by the automated driving function within the (road) surroundings model realm in an automated manner.

The explanations pertaining to the two possibilities can therefore be combined with one another and, if useful from a technical point of view, apply to both possibilities in equal measure.

Besides a cost reduction and speeding up the development of automated driving functions, the method also provides an opportunity to improve the quality of the automated driving function by automating manual processes and data-driven development.

Possible developments of the above method are described in detail below.

The determining of the first variance between the target trajectory determined by the surroundings model and the actual trajectory taken by the motor vehicle can comprise ascertainment of a position and/or a curvature of a center line of a roadway by means of the surroundings model as the target trajectory, and ascertainment of the first variance on the basis of a variance between the position and/or the curvature of the center line and a position and/or a curvature of the actual trajectory.

The determining of the second variance between the road profile determined by the surroundings model and the road profile determined by the camera software can comprise ascertainnent of a position and/or a curvature of a road marking and/or a center line of a roadway by means of the surroundings model as the road profile, ascertainment of a position and/or a curvature of the road marking and/or a center line of the roadway by means of the camera software as the road profile, and ascertainment of the second variance on the basis of a variance between the position and/or the curvature of the road marking and/or the center line that has/have been ascertained by means of the surroundings model and the position and/or the curvature of the road marking and/or the center line that has/have been ascertained by means of the camera software.

The method comprises establishing that a predetermined environmental situation exists, and identifying that there is no malfunction in spite of the second variance.

The determination of the first and/or the second variance can be carried out in the motor vehicle, that is to say online, during a journey and/or by means of a data processing device external to the motor vehicle, that is to say offline, after the journey.

Data used by the automated driving function can be stored in a ring memory when the first and/or the second variance is determined during the journey, i.e., online.

The data stored in the ring memory can be sent from the motor vehicle to the data processing device external to the motor vehicle when the malfunction is identified on the basis of the first and/or the second variance.

The malfunction can be identified when the first and/or the second variance exceed/s a respective predetermined limit value.

The method described above can be summarized in other words and with reference to a more specific configuration, as described in nonlimiting fashion below for the present disclosure.

The intention is to avoid manual steps for the analysis and quality assessment of the road geometry computed by the automated driving function. The quality assessment can take place either online or offline. An online quality assessment (self-monitoring) can be used for automated identification of variances during the journey. This allows malfunctions to be identified in an automated manner, the driver to be asked to take over and/or data to be logged in an automated manner for an offline analysis. Since problematic situations are read in an automated manner, the data can be captured not only by test drivers using special equipment but also in customer vehicles. The increased number of vehicles that are able to log the data can make it easier to record seldomly arising incidents, or malfunction. The logged data can be analyzed and/or incorporated into a training data collection automatically, or in an automated manner.

The disclosure provides for multiple measures in order to detect and analyze abnormal behavior by an automated driving function within the road surroundings model realm automatically.

In one sub-aspect, the disclosure determines a variance between the road profile determined by the automated driving function (road surroundings model) and the actually taken trajectory.

The variance used can be, e.g., the lateral offset between a center line computed by the surroundings model and the actually taken trajectory. Alternatively or additionally, a variance can also be computed on the basis of the steering angle.

The variance can be ascertained either online in the vehicle or offline.

The surroundings model can have multiple sub-models (lane fusion, crowd trajectories, HD map). The invention can be used to evaluate the individual models.

When the variance is being determined online in the vehicle, too great a variance can result in data being logged in an automated manner for further analysis.

The data logging can also be carried out when other critical values are detected, e.g., excessively high curvatures, particularly small or large lane widths, very short or unstable detections of the road markings by the camera, etc.

In another sub-aspect of the disclosure, to which the above description of the first sub-aspect applies mutatis mutandis, i.e., is combinable therewith, a geometry computed by the road surroundings model (i.e., an output from the road surroundings model) can be compared with a geometry of detections of a lane marking and/or estimated center line (i.e., an input into the road surroundings model) that are delivered by a camera software.

There may be at least two reasons for a variance.

Firstly, present detections by the camera may be erroneous, e.g., the camera confuses tar joints or shadow edges with lane markings and/or picks up the geometry (in particular a curvature) of the lane marking incorrectly. There may therefore be provision in the automated driving function for identification that identifies determined special situations (i.e., predetermined scenarios) in which camera misdetections are known to arise often. In this case, present camera detections can be rejected, and disregarded when computing the road surroundings model. The variance may be consciously wanted in this case.

Secondly, the variances can also arise in spite of correct input data as a result of erroneous processing in the surroundings model. This may be an unwanted variance that is an indication of a possible processing error in the surroundings model.

The determined special situations (scenarios) can serve as a criterion for determining the reason for the variance.

Another indication of abnormal behavior by the road surroundings model may be control being taken over by the driver (so-called driver takeover). The driver can be asked to take over control of the vehicle, e.g., when self-monitoring discovers an error, or the driver takes over control on their own initiative, e.g., when the driver discovers abnormal behavior.

The driver takeover can be used as a trigger for data logging. However, it can also, i.e., additionally or alternatively, serve as a criterion for analysis of the reason for the abnormal behavior by the vehicle.

If the geometries from the road surroundings model and the camera detections match at the time of a driver takeover, this may be an indication of an error in the camera software, but if a variance exists then this may be an indication of an error in the road surroundings model.

The data logging can use a ring buffer, and so at the start of a logging the period before the incident, or the malfunction, is also logged as well. This permits analysis of the initiation of the variance.

The logged data can be transmitted from the motor vehicle, e.g., from the customer vehicle, to a cloud (e.g., of the vehicle manufacturer). This allows, in particular worldwide, statistics from all and/or predetermined customer vehicles to be determined for the anomalies.

The method can therefore be used for error analysis. Statistical evaluation allows the commonest error patterns to be focused on.

The automated logging can be used to determine geographical hotspots of abnormal behavior.

The method can be used to establish that there is an erroneous component of the automated driving function (e.g., camera software, lane marking fusion, localization, crowd trajectory map, HD map, etc.).

Object and/or obstacle information can also be included to determine reasons for the detour, or the variant trajectory.

The logged data can be automatically incorporated into a training database for the automated driving function and/or can be fed to a supplier of the automated driving function and/or the camera software to improve the automated driving function or the camera software.

Furthermore, a device for data processing is provided that comprises means for carrying out the method described above. The device for data processing can also be referred to as a system for data processing or as a data processing device.

The data processing device may be configured so that at least part is installed in and/or on an automated motor vehicle and/or at least part is part of a cloud.

The data processing device may be part of a driving assistance system, or an automated driving function, or can be and/or execute the driving assistance system. The data processing device can have an electronic control unit (ECU). The data processing device can have an intelligent processor-controlled unit that can e.g. use a central gateway (CGW) to communicate with other modules and that can form the vehicle electrical system, if necessary using field buses, such as the CAN bus, LIN bus, MOST bus and FlexRay, or using automotive Ethernet, e.g. together with telematics controllers. It is conceivable for the controller to control functions relevant to the driving behavior of the motor vehicle, such as engine control, force transmission, the brake system and/or the tire pressure monitoring system. Additionally, driver assistance systems, for example a park assist system, an adaptive cruise control (ACC) system, a lane departure warning system, a lane change assist system, a road sign recognition system, a light signal recognition system, a start-off assist system, a night vision assist system, an emergency brake assist system and/or an intersection assist system, can be controlled by the controller.

It is conceivable for the data processing device to control automated driving of the automated motor vehicle at least in part and/or temporarily on the basis of an output from a surroundings model.

The description above with regard to the methods also applies, mutatis mutandis, to the data processing device, and vice versa.

Furthermore, an automated motor vehicle can be provided that has the data processing device described above.

The motor vehicle may be a passenger car, in particular an automobile.

The automated motor vehicle may be configured to undertake longitudinal guidance and/or lateral guidance by means of the automated driving function at least in part and/or at least temporarily during automated driving of the motor vehicle. The automated driving can be controlled by means of the automated driving function at least in part and/or temporarily by the data processing device.

The automated driving can take place such that the motor vehicle moves along (largely) autonomously.

The motor vehicle may be an autonomy level 0 motor vehicle, i.e., the driver undertakes the dynamic driving task even if assistive systems (e.g., ABS or ESP) are present.

The motor vehicle may be an autonomy level 1 motor vehicle, i.e., can have specific driver assistance systems that assist the driver in vehicle operation, for example adaptive cruise control (ACC).

The motor vehicle may be an autonomy level 2 motor vehicle, i.e., may be partially automated in such a way that functions such as automatic parking, keeping in lane, or lateral guidance, general longitudinal guidance, acceleration and/or braking are undertaken by driver assistance systems.

The motor vehicle may be an autonomy level 3 motor vehicle, i.e., may be conditionally automated in such a way that the driver does not have to continuously monitor the vehicle system. The motor vehicle independently performs functions such as activating the turn signal indicator, changing lane and/or keeping in lane. The driver can turn to other things, but if required is asked by the system to take over guidance within an advance warning time.

The motor vehicle may be an autonomy level 4 motor vehicle, i.e., may be highly automated in such a way that guidance of the motor vehicle is undertaken by the vehicle system on an ongoing basis. If the driving tasks are no longer coped with by the system, the driver can be asked to take over guidance.

The motor vehicle may be an autonomy level 5 motor vehicle, i.e., may be fully automated in such a way that the driver is not required in order to perform the driving task. Apart from stipulating the destination and starting the system, no human intervention is required.

The description above with regard to the methods and the data processing device also applies, mutatis mutandis, to the motor vehicle, and vice versa.

Furthermore, a computer program is provided. The computer program is distinguished in that it comprises conunands that, when the program is executed by a computer, cause the computer to carry out the described method at least in part.

A program code of the computer program may be available in any desired code, in particular in a code suitable for control systems of motor vehicles.

Furthermore, a computer-readable medium, in particular a computer-readable storage medium, is provided. The computer-readable medium is distinguished in that it comprises commands that, when the program is executed by a computer, cause the computer to carry out the method described above at least in part.

That is to say that a non-transitory computer-readable medium can be provided that comprises a computer program as defined above. The computer-readable medium may be any desired digital data storage device, for example a USB stick, a hard disk, a CD-ROM, an SD card or an SSD card. The computer program does not necessarily have to be stored on a computer-readable storage medium such as this in order to be made available to the motor vehicle, but rather may also be sourced via the Internet or in some other external manner.

The description above with regard to the methods, the data processing device and the automated motor vehicle also applies, mutatis mutandis, to the computer program and the computer-readable medium, and vice versa.

An embodiment is described below with reference to FIGS. 1 to 3.

### BRIEF DESCRIPTION OF THE DRAWINGS

FIG. 1 schematically shows a flowchart for a method for identifying a malfunction in a surroundings model used by an automated driving function of a motor vehicle,

FIG. 2 schematically shows a first plan view of a road surface to explain the determining of a first variance between a target trajectory determined by the surroundings model and an actual trajectory taken by the motor vehicle, and

FIG. 3 schematically shows a second plan view of a road surface to explain the detennining of a first variance between a target trajectory determined by the surroundings model and an actual trajectory taken by the motor vehicle.

### DETAILED DESCRIPTION OF THE DRAWINGS

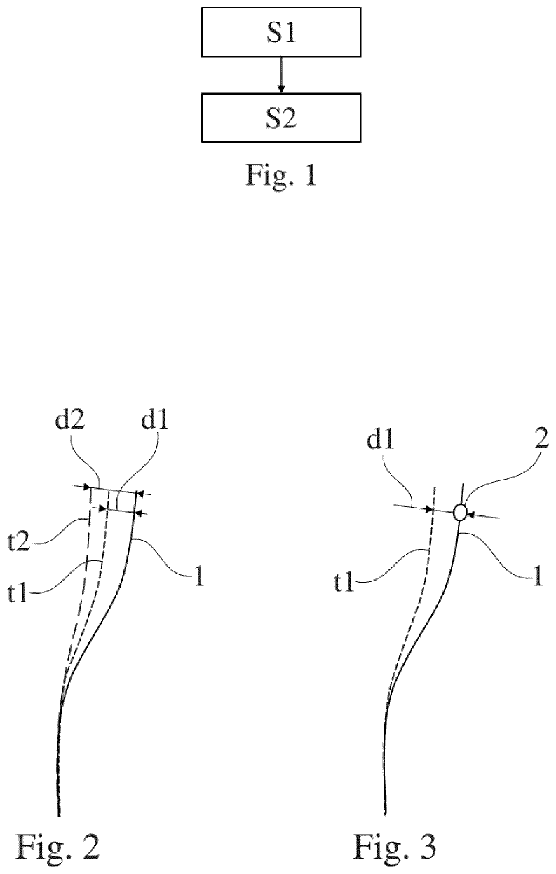

As can be seen from FIG. 1, the method for identifying the malfunction in the surroundings model used by the automated driving function of the motor vehicle essentially has two steps, S1 and S2.

In a first step of the method, a first variance between a target trajectory determined by the surroundings model and an actual trajectory taken by the motor vehicle is detennined. Additionally or alternatively, a second variance between a road profile determined by the surroundings model and a road profile determined by a camera software is determined. A few ways in which this can be implemented specifically are described in detail below with reference to FIGS. 2 to 3, this not being a comprehensive description of the implementation options but rather merely being used for explanatory purposes.

The determining of the first variance between the target trajectory determined by the surroundings model and the actual trajectory taken by the motor vehicle can comprise ascertainment of a position of a center line of a roadway by means of the surroundings model as the target trajectory and ascertainment of the first variance on the basis of a variance between the position of the center line and the position of the actual trajectory.

This is depicted for a global coordinate system in FIG. 2 by way of illustration. The trajectory taken, or actual trajectory 1, which is determined by way of an odometry for the motor vehicle and is represented by a solid line in FIG. 2, is compared with data from the surroundings model, here a center line t1, t2 at different times, represented by a dashed line in each case, in the global coordinate system. This is accomplished by entering the odometry data, in particular position information, and the center lines t1, t2 from a time interval into the global coordinate system. This is depicted for two different times t1 and 12 in FIG. 2 by way of illustration. The respective variances between the real trajectory, or actual trajectory 1, and the computed center line t1, t2 of the surroundings model at different times are then determined at the location, or position, that the motor vehicle was in at the time the center line was determined. The variance may be the perpendicular distance between the actual trajectory 1 and the computed center line t1, t2 or, as depicted in FIG. 2, the shortest distance d1 or d2 between the actual trajectory 1 and the computed center line t1, t2. The distance d1, d2 between these can be at least included for computing, or ascertaining, the first variance. Additionally or alternatively, a curvature of the center line and a curvature of the actual trajectory can be determined at the respective positions of the motor vehicle and the difference between the curvatures can be at least included for computing, or ascertaining, the first variance. This can be accomplished by using a steering angle of the motor vehicle, i.e., the respective curvature of the center line t1, t2 can be determined at different positions and determined with the actual steering angle of the motor vehicle at the respective position. It is also conceivable for the center lines of the surroundings model to be preprocessed, e.g., for a single global center line to be produced from the center lines of the multiple time steps, or times t1, t2, and for the variance, e.g., the maximum distance between the actual trajectory and this global center line, to be determined.

As depicted in FIG. 3, a coordinate system of the motor vehicle, i.e., a relative coordinate system, can also be used to determine the first variance. Analogously to the determination of the variance by means of the global coordinate system, as described above with reference to FIG. 2, this can involve the present position 2, or actual position, of the motor vehicle being compared with a present target position of the motor vehicle that is on the center line t1, and the distance d1 being determined as a result. This can take place continually. Determination of the first variance using the relative coordinate system may be suitable in particular when the variance is determined online during the journey, and can take place continually. The center line t1 used therefor can be ascertained in the same time step or in an earlier time step. That is to say that the present position 2 of the vehicle can be compared with a target position that the surroundings model had determined at a time in the past (e.g., t=0). The curvature of the center line t1 and the present steering angle can likewise be compared analogously to the manner described above.

It is also conceivable for the center line t1, t2 to be ascertained both by the surroundings model and by a camera software. That is to say that it is then possible for a position and/or a curvature of the center lines t1, t2 to be ascertained by means of both the camera software and the surroundings model, and a variance between the position and/or the curvature of the center lines can be determined. The variance between the center lines, e.g., the lateral offset between them (see above), can be at least included for computing, or ascertaining, the second variance. It would also be conceivable, in addition or as an alternative to the center line, to use a road marking in this manner. That is to say that a position and/or a curvature of a road marking can then be ascertained by means of both the camera software and the surroundings model, and a variance between the position and/or the curvature of the road markings can be determined. The variance between the road markings, e.g. the lateral offset between them (see above), can be at least included for computing, or ascertaining, the second variance.

In a second step S2 of the method, the malfunction is identified on the basis of the first and/or the second variance, the malfunction being identified when the first and/or the second variance exceed/s a respective predetermined limit value. It is conceivable for the second variance not to be used when it is established that a predetermined environmental situation exists. That is to say that there may be provision in the automated driving function for identification that identifies predetermined environmental situations, or special situations (i.e., predetermined scenarios), in which camera misdetections are known to arise often. In this case, present camera detections can be rejected, and disregarded when computing the surroundings model. The variance may be consciously wanted in this case. In such a case, it is therefore possible to identify that there is no malfunction in spite of the second variance that exceeds the limit value.

The above-described determination of the first and/or the second variance can be carried out in the motor vehicle during a journey and/or by means of a data processing device external to the motor vehicle after the journey. The same applies to the above-described identification of the malfunction on the basis of the first and/or the second variance. Data that are used by the automated driving function can be stored in a ring memory when one or two of these steps take place during the journey. The data stored in the ring memory can be sent from the motor vehicle to the data processing device external to the motor vehicle when the malfunction is identified on the basis of the first and/or the second variance. Additionally or alternatively, the data can be logged using a logging device, in particular a data logger, and/or sent to the data processing device external to the motor vehicle, in particular streamed into a backend or a cloud, throughout the journey or on parts of the journey irrespective of whether a malfunction is identified.

### List of Reference Signs

1 actual trajectory
2 present position of the motor vehicle
t1, t2 target trajectory at different times
d1, d2 distance between actual trajectory and the respective target trajectory at the different times
S1, S2 steps of the method

1.-10. (canceled)

11. A method for identifying a malfunction in a surroundings model used by an automated driving function of a motor vehicle, the method comprising:
determining at least one of a first variance between a target trajectory determined by the surroundings model and an actual trajectory taken by the motor vehicle and a second variance between a road profile determined by the surroundings model and a road profile determined by a camera software; and
identifying the malfunction based on at least one of the first variance and the second variance.

12. The method according to claim 11, wherein the determining of the first variance between the target trajectory determined by the surroundings model and the actual trajectory taken by the motor vehicle comprises:
determining, by the surroundings model, at least one of a position and a curvature of a center line of a roadway as the target trajectory; and
determining the first variance based on a variance between the position or the curvature of the center line and a position or a curvature of the actual trajectory.

13. The method according to claim 11, wherein the determining of the second variance between the road profile determined by the surroundings model and the road profile determined by the camera software comprises:
determining, by the surroundings model, at least one of a position and a curvature of a road marking or a center line of a roadway as the road profile;
determining, by the camera software, at least one of a position and a curvature of the road marking or a center line of the roadway as the road profile; and
determining the second variance based on a variance between the position or the curvature of the road marking or the center line that has been determined by the surroundings model and the position or the curvature of the road marking or the center line that has been determined by the camera software.

14. The method according to claim 12, wherein the determining of the second variance between the road profile determined by the surroundings model and the road profile determined by the camera software comprises:
determining, by the surroundings model, at least one of a position and a curvature of a road marking or a center line of a roadway as the road profile;
determining, by the camera software, at least one of a position and a curvature of the road marking or a center line of the roadway as the road profile; and
determining the second variance based on a variance between the position or the curvature of the road marking or the center line that has been determined by the surroundings model and the position or the curvature of the road marking or the center line that has been determined by the camera software.

15. The method according to claim 11, the method further comprising:
establishing that a predetermined environmental situation exists; and
identifying that there is no malfunction in spite of the second variance.

16. The method according to claim 12, the method further comprising:
establishing that a predetermined environmental situation exists; and
identifying that there is no malfunction in spite of the second variance.

17. The method according to claim 13, the method further comprising:
establishing that a predetermined environmental situation exists; and
identifying that there is no malfunction in spite of the second variance.

18. The method according to claim 11, wherein the determination of at least one of the first variance and the second variance is carried out in the motor vehicle during a journey or by a data processing device external to the motor vehicle after the journey.

19. The method according to claim 12, wherein the determination of at least one of the first variance and the second variance is carried out in the motor vehicle during a journey or by a data processing device external to the motor vehicle after the journey.

20. The method according to claim 13, wherein the determination of at least one of the first variance and the second variance is carried out in the motor vehicle during a journey or by a data processing device external to the motor vehicle after the journey.

21. The method according to claim 15, wherein the determination of at least one of the first variance and the second variance is carried out in the motor vehicle during a journey or by a data processing device external to the motor vehicle after the journey.

22. The method according to claim 18, wherein data used by the automated driving function is stored in a ring memory when the first variance or the second variance is determined during the journey.

23. The method according to claim 22, wherein the data stored in the ring memory is sent from the motor vehicle to the data processing device external to the motor vehicle when the malfunction is identified based on the first variance or the second variance.

24. The method according to claim 11, wherein the malfunction is identified when the first variance or the second variance exceeds a respective predetermined limit value.

25. The method according to claim 12, wherein the malfunction is identified when the first variance or the second variance exceeds a respective predetermined limit value.

26. The method according to claim 13, wherein the malfunction is identified when the first variance or the second variance exceeds a respective predetermined limit value.

27. The method according to claim 15, wherein the malfunction is identified when the first variance or the second variance exceeds a respective predetermined limit value.

28. A device for data processing, wherein the device is configured to carry out the method according to claim 11.

29. A non-transitory computer-readable medium comprising commands that, when executed by a computer, cause the computer to carry out the method according to claim

11.
